(19) United States
(12) Patent Application Publication
(10) Pub. No.: US 2007/0233745 A1
(43) Pub. Date: Oct. 4, 2007

(54) Data Flow Optimization in Meta-Directories

(76) Inventor: Ori Pomerantz, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/277,780

(22) Filed: Mar. 29, 2006

(51) Int. Cl. G06F 17/30

(52) U.S. Cl. 707/200

(57) ABSTRACT

A system and method for producing a meta-directory integrator having improved data flow which accumulate a list of input, calculated, attributes, intermediate output, and final output attributes by traversing from a first connector function to a last connector function in a first meta-directory integrator; by performing data flow analysis to yield an indicator for each found attribute which neither directly or indirectly contribute to final output attributes; modifying the program code associated with the connector functions of the first integrator eliminate accessing or storing the unused input attributes; and producing a second meta-directory integrator from the modified connector function program such that the second meta-directory integrator has improved data flow and utilization of system resources.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

None.

### BACKGROUND OF THE INVENTION

1. Field of the Invention

This invention relates management and optimization of data flow meta-directory products to promote more effective and efficient meta-directory usage and access.

2. Background of the Invention

With the vast amount of information electronically available today, businesses are using directories to hold and organize data in manners which are relevant to their needs. Directories can be viewed as a special type of database that stores data organized in a family or tree-like hierarchy. Many newer design directories can be accessed by different directory clients, often remotely, using one of several directory access protocols such as Lightweight Directory Access Protocol (“LDAP”), Directory Access Protocol (“DAP”), and X.500. Products such as Microsoft's Active Directory, Netscape's Communicator Suite, and Novell's NetWare Directory Services incorporate or support such protocols for enhanced and extended functionality.

Using such a directory access protocol, data within a directory can be stored in a single directory server, or can be easily integrated as a part of an application, service or device. In fact, a distributed directory services structure can be created to allow one directory server to interoperate with other directory servers.

Frequently, it is not practical to find all information to reside in a single datasource. Because needed information is often stored or spread across more than one directory or database within the distributed environment, and because all of these data stores may be of different designs, protocols, and platforms, the use of “meta-directories” has become prevalent in the Information Technology industry.

Meta-directories consolidate relevant information into a single, presentable format, without the requiring of knowledge of exactly where and how each data item is specifically stored. Meta-directories do not copy the data into a single storage medium, however, but rather “join” disparate directories underneath one virtual directly. To accomplish this, a meta-directory server receives access requests in a common protocol, such as LDAP, and converts these accesses to appropriate transactions or commands compatible with the specific targeted data source or directory.

As such, meta-directories are essentially collections of data directories presented to users or computer clients as a single directory with its associated summary. When changes are made to one or more items represented in the meta-directory, the meta-directory product must implement the appropriate updates using predefined synchronization guidelines and rules. This requires meta-directories to be readily extensible in order to support and manage the different data sources and configuration changes as it occurs.

IBM Corporation's (“IBM”) Tivoli Directory Integrator™ (“TDI”) is an application tool that synchronizes identity data residing in directories, databases and collaborative systems. TDI successfully accomplishes this by addressing three main aspects of such data integration:
a) “Datasources” can consist as a mixture common database formats, such as DB2 and Oracle's SQLServer databases, and as various directory services;
b) “Data flow” techniques are used to represent and analyze how communications are accomplished between two or more data stores or directory server systems; and
c) “Events” initiate when one set of datasources communicate with other datasources.

Customarily, TDI performs integration of datasource by means of manually configured “AssemblyLines”. Similar in concept to manufacturing AssemblyLines, a TDI AssemblyLine specifies data access actions to be performed at each step or phase of a sequential process of integration of data.

By using a variety of widely available data flow diagramming and analysis tools, traditional diagram flow arrows are translated into TDI's AssemblyLines definitions. These definitions represent an ordered list of components that make-up a single path of data transfer and transformation. Various input units feed into an AssemblyLine step or phase, which are processed to generate results, which may be used by the next step or phase in the AssemblyLine, or may be stored in a datasource.

In TDI, both the input and output components are known as “Connectors”. Typically, there is more than one connector involved in a TDI AssemblyLine process. In this way, TDI manages the components in an orderly sequential fashion by processing it one at a time rather than performing a batch job for all the connectors at once.

By utilizing standard dataflow analysis techniques in conjunction with the TDI AssemblyLines, the connectors are defined to perform explicit job functions for each input, and to generate the appropriate outputs. Traditional dataflow analysis techniques are well known, and are often used to discover dependencies between different data items manipulated by a program, module, or the overall information system.

TDI AssemblyLines can pull data from one datasource in a meta-directory, optionally process or modify it, and then send it to another datasource in a meta-directory for further calculation, use or storage, and then place the new result data into a new datasource.

To enable quicker and more robust AssemblyLine design, many “standard” or library AssemblyLine connectors have been developed in a manner which lends itself to reuse of the connectors. By accessing these library connectors, an AssemblyLine designer can quickly prototype and test a new AssemblyLine with minimal coding from scratch.

A considerable disadvantage to using the standard meta-directory functions is the fact that, due to their more general purpose nature, they often retrieve all kinds of related, but unneeded, information during function performance. For example, if a salary report for a department store is being generated using data stored in several directories of a meta-directory, an AssemblyLine may receive in response to its queries by employee number to a first datasource data information including employee names and average work hours. All of this information is generally returned by the datasources in response to a query for any one of the data items, in this example, because it represents entire “records” or “rows of data” from the underlying database of the first datasource. Next, the AssemblyLine may only need to use the retrieved employee names to query and second datasource in the meta-directory to obtain each employee's work hours and salary, but may also receive responsive to the query other unneeded data items in the records such as dates of birth, employment start dates, job grade, etc.

While the AssemblyLine can now effectively calculate salary information for the desired report, the ignored and unnecessary retrieved information represents waste of system resources, such as memory, communications bandwidth, and directory server processor bandwidth. This is especially wasteful in large operations, such as processing of thousands of names in the previous example, and in geographically disparate meta-directories, such as meta-directories having directory servers distributed by networks over long distances.

### SUMMARY OF THE INVENTION

To address the problems discussed in the foregoing paragraphs, and other problems which will be evident through the present disclosure, the invention provides data flow optimization in meta-directory products to enhance the efficiency of resource consumption by eliminating or reducing the access, transmission, and storage of unneeded and unnecessary information and data items during integration processing.

Instead of relying on the implementer to produce the most efficient AssemblyLine possible, the present invention uses data-flow analysis to automatically determine exactly which attributes of the input are used for which attributes of the output. Any input attributes which are not employed in obtaining or generating output attributes, either directly or indirectly, represent unnecessary and unneeded memory and bandwidth consumption.

### BRIEF DESCRIPTION OF THE DRAWINGS

The following detailed description when taken in conjunction with the figures presented herein provide a complete disclosure of the invention.

FIG. 1 provides a top-level view of the design of the present invention.

FIGS. 2a and 2b show a generalized computing platform architecture, and a generalized organization of software and firmware of such a computing platform architecture.

FIG. 3a illustrates a basic connector component of a Tivoli Directory Integrator AssemblyLine.

FIG. 3b provides an illustration relative to an example data flow.

FIGS. 4a and 4b also provide an illustration relative to another example data flow.

FIGS. 5a and 5b illustrate a logical process according to the present invention.

### DESCRIPTION OF THE INVENTION

In the following paragraphs, the invention will be disclosed in terms of specific embodiments compatible with and in conjunction with IBM's Tivoli Directory Integrator. It will be recognized by those skilled in the art, however, that many alternative embodiments are available, to support a variety of possible combinations with other directory integration products. Throughout the following disclosure, the terms “optimize”, “optimized” and “optimizing” shall be used to mean the state of being improved, or process of improving, something with respect to certain aspects of data flow and system resource consumption, such as the second entry of the definition:

optimize:
1. To make as perfect or effective as possible.
2. Computer Science. To increase the computing speed and efficiency of (a program), as by rewriting instructions.
3. To make the most of.
(Source: Dictionay<dot>com)

The use of the term “optimize” and variations thereof should not be construed to exclusively mean attainment of absolute optimum, or perfection.

The way that data travels from one datastore to another in TDI is through “attributes” in the work object. Each of these attributes is either a direct copy of an attribute from a data store, or the result of a processing function, such as a JavaScript™ operation. According to one aspect of the invention, which input attributes are retrieved by the AssemblyLine is determined by examining the code of the AssemblyLine connectors for functions that retrieve data, such as JavaScript™ getString calls. One exception to this approach is when an attribute's NAME is calculated on the fly, which is generally a rare occasion in AssemblyLine designs.

Similarly, every output attribute is set normally from an output map, either as a copy of an attribute in the work object or the result of a JavaScript calculation. Again, it is possible to determine which work attribute(s) affected the output attribute. This way, the invention determines which input attributes affect which output attributes. If an input attribute doesn't affect any of the output attributes, then there's no need to read it, and resources are saved by eliminating access of those input attributes.

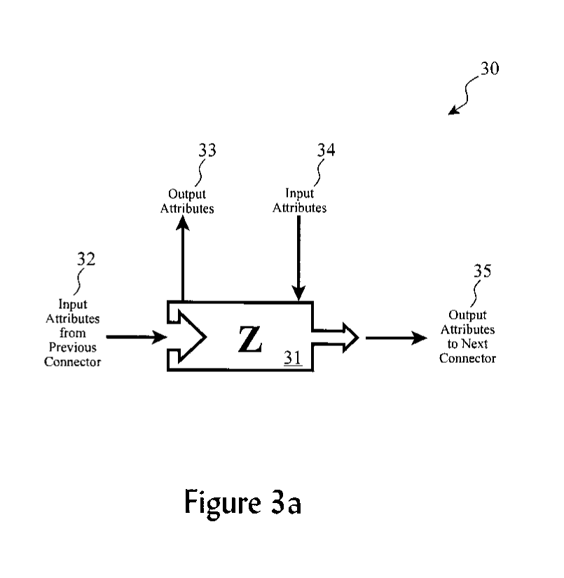

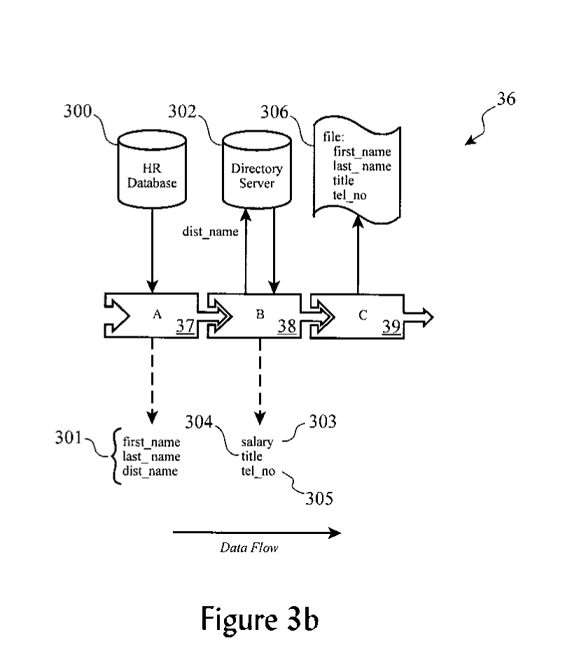

Turning to FIG. 3a, a typical TDI connector processing stage (30) is shown. One or more input attributes (32) are typically received from a previous connector. a process Z (31) receives the input attributes (32) from the previous connector, and generates one or more output attributes (33) to datasources in the meta-directory in order to perform one or more queries of those datasources. The output attributes (33) may be copies of one or more of the input attributes (32), they may be calculated based upon those input attributes (32), or a combination of both.

Responsive to the queries, one or more input attributes (34) are received from one or more datasources of the meta-directory. From the totality of the input attributes (32, 34), new output attributes (35) to the next connector are calculated and passed to the next connector. In determining these output attributes (35) to pass to the next connector, the function Z may copy one or more input attributes (32, 34), calculate one or more output attributes based on one or more input attributes (32, 34), or a combination of both.

To illustrate the problem of retrieving unnecessary input attributes, we now turn to FIG. 3b in which data flow progresses generally from left to right. In this AssemblyLine (36), three “library” or “standard” connectors are used to perform functions A (37), B (38), and C (39), in this sequence. The first connector receives no input attributes from a previous connector, as it is the first connector in the AssemblyLine. This first connector executes function A (37) to access to a directory server (300) via a meta-directory (307) in order to extract attributes “first_name”, “last_name”, and “dist_name” (301). In this example, the attribute “dist_name” is an unique identifier within the directory server to ensure that there are no duplicates for each record, such as a social security number or employee number.

Next, the second connector receives the distinctive name attribute “dist_name” from the first connector, and function B uses this parameter in a meta-directory query to a Human Resources Database (302) to obtain records containing “salary” (303), “title” (304), and “tel_no” (305) attributes from the HR database (302). Additionally, the second connector's function B receives the “first_name” and “last_name” attributes from the first connector, and passes them through to the third connector.

Finally, the third connector receives the passed-through “first_name” and “last_name” attributes (301) from the second connector, as well as the “salary” (303), “title” (304), and “tel_no” (305) attributes. Function C then creates an output file (306) containing only the “first_name”, “last_name” (301), “title” (304), and “tel_no” (305) attributes.

So, while this AssemblyLine performs the functionality as desired (e.g. produce a file containing employee names, titles, and telephone numbers), its execution in a real, live environment to produce such a report for 25,000 employees would consume excessive memory and bandwidth when unnecessarily accessing and storing 25,000 “salary” attributes. In a more complicated AssemblyLine, such as an AssemblyLine with six connectors and sixty attributes, many more attributes may be unnecessarily accessed and stored, further exasperating the illustrated problem.

The present invention determines by data flow analysis functions that the attribute “dist_name” is used during intermediate processing, but is not directly part of the output from the final connector (e.g. “dist_name” contributes indirectly to output attributes). Also, the invention determines that the “first_name”, “last_name” (301), “title” (304), and “tel_no” (305) attributes are present in the output attributes, and as such, as input attributes to the first and second connectors, they contribute directly to output attributes. However, the present invention also determines using data flow analysis that the “salary” (303) attribute which is extracted from the HR database intrinsically has no value because it is neither needed nor shown in the final output attributes (e.g. it neither directly or indirectly contributes to output attributes).

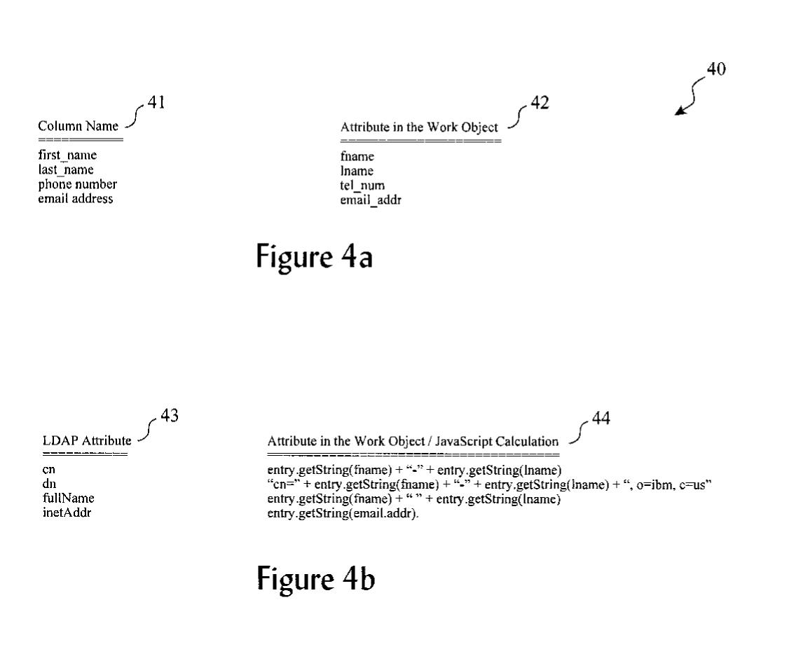

FIGS. 4a and 4b illustrate (40) in tabular format an AssemblyLine similar to the immediately previous example, in which a first connector's input attributes (42) which are received responsive to a query upon a set of field names or column names (41). As shown in FIG. 4b, a second connector, or alternatively additional JavaScript functionality within the first connector, can employ the “fname” and “lname” attributes received (42) from the first query to calculate and obtain other attributes, such as LDAP attributes (43). JavaScript implementation (44) examples are provided, as JavaScript is employed in one available embodiment. It will be readily recognized by those skilled in the art that alternative programming or scripting languages and methodologies can also be used, as well.

In this second example, data flow analysis performed by the invention determines that the “tel-num” attribute is never used, either directly or indirectly, to obtain attributes or calculate attributes which are needed for output attributes.

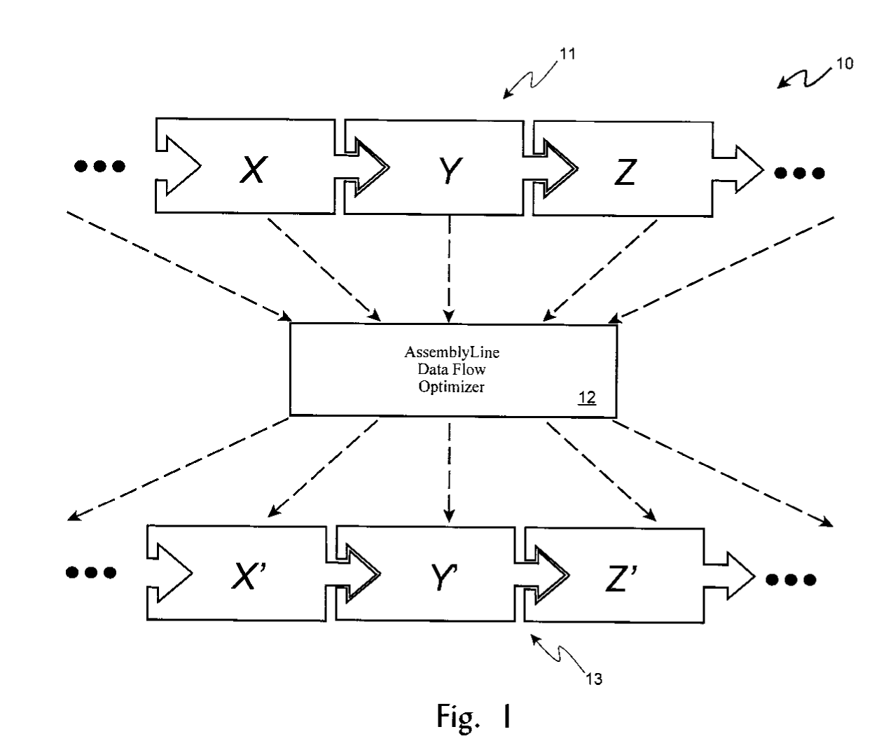

FIG. 1 illustrates (10) from a high level the system operation of the present invention, in which a number of generalized or library connectors initially perform the desired functionality of an AssemblyLine (11) by performing functions X, Y, Z, etc., in a predetermined sequence.

The present invention (12), referred to as an AssemblyLine Flow Optimizer (“ALFO”), receives the code for these connectors, such as the JavaScript code, and analyzes the code using well known data flow analysis methods to determine which input attributes do not contribute directly or indirectly to output attributes. For these unnecessary input attributes, the code is examined to find each function, call or program statement which causes these attributes to be accessed or stored, and each such function, call, or program statement is modified to eliminate or minimize such access and storage.

These modified code sources for the connectors are then output to produce an optimized AssemblyLine (13), in which corresponding functions X′, Y′, Z′, etc., are optimized versions of the original functions X, Y, Z, etc.

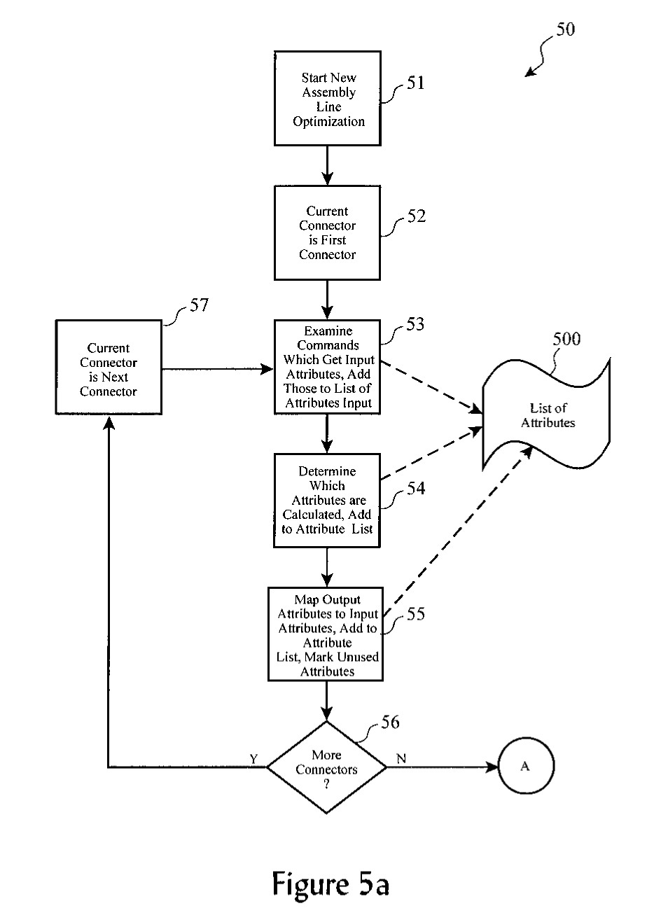

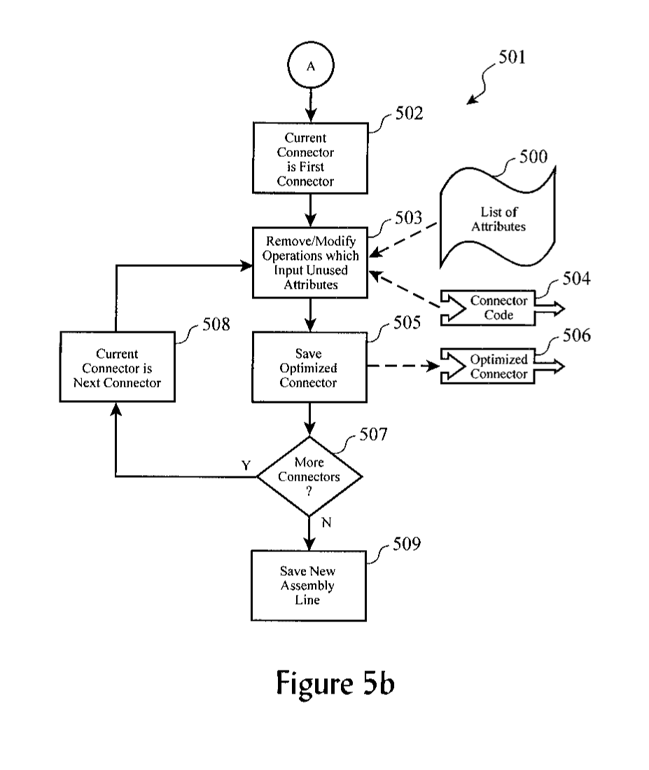

A logical process (50) according to the present invention is shown (50, 501) in FIGS. 5a and 5b. The AssemblyLine optimization process begins (51) by examining the code for the first connector (52) in the AssemblyLine. The code is parsed and analyzed (53) to identify calls, functions, or program statements which access input attributes, adding each accessed input attribute to a list of attributes (500). The process also determines (54) which attributes are calculated, and adds these attributes to the attribute list (500), as well.

Next, through identification of the commands, calls, or program statements found, output attributes are mapped to input attributes in the list of attributes.

Then, the same functions are performed for each of the remaining connectors (56, 57, 58, 54, 55), until each connector's code has been analyzed, and a comprehensive list of input attributes has been mapped to a comprehensive list of output attributes.

For example, as discussed relative to the example of FIG. 3b, the attribute list (500) may appear as shown in Table 1, wherein the asterisk “*” denotes output attributes in the desired or final output data.

TABLE 1
Example Attribute List

| Input or Calculated | Used by Function or | Output | |
|---|---|---|---|
| Attribute | Connector | Attribute | Used |
| first_name | A | first_name | ? |
| last_name | A | last_name | ? |
| dist_name | A | dist_name | ? |
| dist_name | B | salary | ? |
| dist_name | B | title | ? |
| dist_name | B | tel_no | ? |
| first_name | B | first_name | ? |
| last_name | B | last_name | ? |
| first_name | C | first_name* | Y |
| last_name | C | last_name* | Y |
| title | C | title* | Y |
| tel_no | C | tel_no* | Y |

In determining which attributes actually yield final output *, data flow analysis builds a path for each output attribute backwards to all input attributes used to generate or retrieve that output attribute. For example, the output attribute “tel_no” is directly related to the input attribute accessed by function A as follows:
A>dist_name>B>tel_no>C>tel_no* Eq. 1

More detail to such a flow can be added showing the datasources, as follows:
Dir_svr_(300)>dist_name>A>dist_name>B>dist_name>HR_(302)>tel_no>B>title>C>file_(306) Eq. 2

For each attribute found to be in a path resulting in an output, the corresponding entry in the attribute list (500) is marked to indicate the attribute is “used”, as shown in the example of Table 2.

TABLE 2
Example Marked Attribute List

| Input or Calculated | Used by Function or | Output | |
|---|---|---|---|
| Attribute | Connector | Attribute | Used |
| first_name | A | first_name | Y |
| last_name | A | last_name | Y |
| dist_name | A | dist_name | Y |
| dist_name | B | salary | ? |
| dist_name | B | title | Y |
| dist_name | B | tel_no | Y |
| first_name | B | first_name | Y |
| last_name | B | last_name | Y |
| first_name | C | first_name* | Y |
| last_name | C | last_name* | Y |
| title | C | title* | Y |
| tel_no | C | tel_no* | Y |

Any remaining, unmarked attributes are then assumed to be unused by reason of elimination, as shown in Table 3.

TABLE 3
Example Completely Marked Attribute List

| Input or Calculated | Used by Function or | Output | |
|---|---|---|---|
| Attribute | Connector | Attribute | Used |
| first_name | A | first_name | Y |
| last_name | A | last_name | Y |
| dist_name | A | dist_name | Y |
| dist_name | B | salary | N |
| dist_name | B | title | Y |
| dist_name | B | tel_no | Y |
| first_name | B | first_name | Y |
| last_name | B | last_name | Y |
| first_name | C | first_name* | Y |
| last_name | C | last_name* | Y |
| title | C | title* | Y |
| tel_no | C | tel_no* | Y |

As shown in FIG. 5b, the logical process then selects (502) the first connector in the AssembyLine, and removes or modifies (503) the functional code (504) for that connector which accesses or reads any of the attributes marked as not used in the attribute list (500). For example, a JavaScript code which originally uses a getString function to obtain an entire 120 byte record as follows:

$$\begin{matrix}full\_record = HR\_record ( dist\_name ) \\ = title + salary + tel\_no\end{matrix} \qquad Eq . 3$$

where the “title” attribute consumes the first 50 bytes, the “salary” attribute consumes the next 25 bytes, and the “tel_no” attribute consumes the last 45 bytes of the record, would be replaced with two getString functions to avoid accessing the unneeded 25-byte “salary” field, as follows:
title=HR_record(dist_name, 0, 49) Eq. 4
tel_no=HR_record(dist_name, 74, 119) Eq. 5

where the query parameters are the key field “dist_name” followed by the first byte number (zero based in this example) to read, through to the last byte number as the third query parameter.

Other operations which only access unused input attributes are eliminated or deleted from the code. The modified code is then saved (505) as an optimized connector (e.g. one tailored to the overall needs of the AssemblyLine in which it is used).

The process of examining each of the remaining connector's code (504), modifying (503) the code, and saving (505) optimized connectors (506), is continued (507, 509), until all connectors in the original AssemblyLine have been optimized, at which time the optimized AssemblyLine is complete (509).

The invention as just described is in one embodiment realized in part or whole as a software product in conjunction with a suitable computing platform to produce a system. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

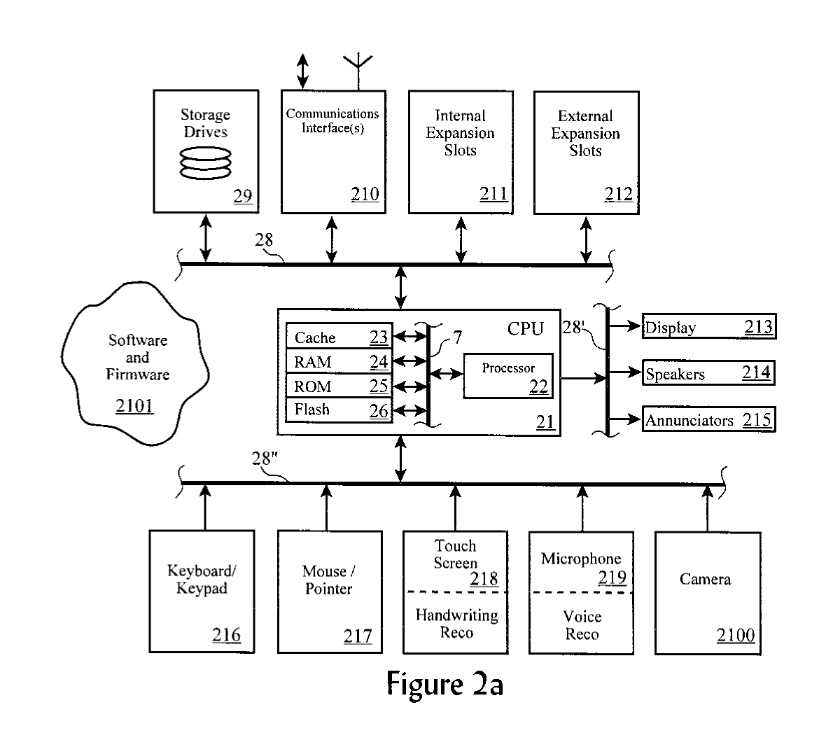

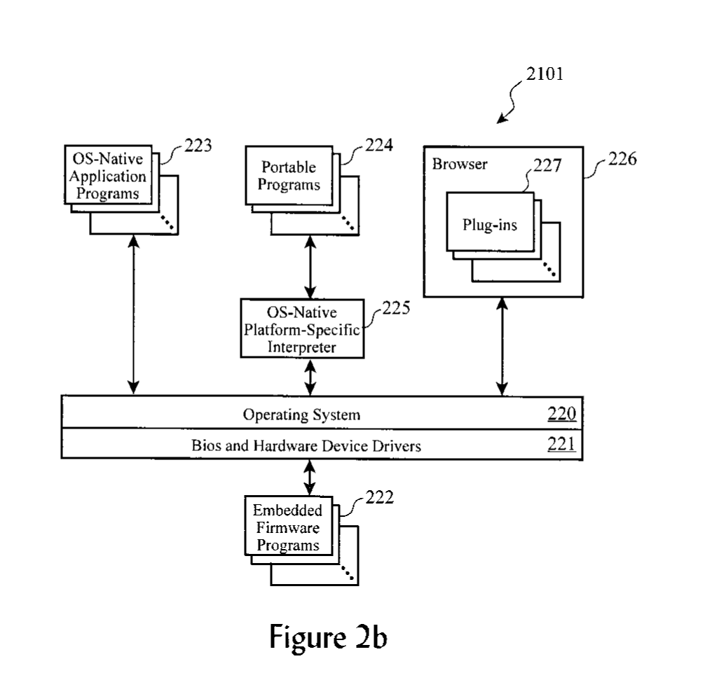

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units.

It will be readily recognized by those skilled in the art that the aforementioned methods, processes, devices and apparatuses may be alternatively realized as hardware functions, in part or in whole, without departing from the spirit and scope of the invention. Further, alternate programming methodologies or languages may be used, as well as integration or cooperation with alternative meta-directory products may be made. For these reasons, the scope of the present invention should be determined by the following claims.

What is claimed is:

1. A method of producing a meta-directory integrator having improved data flow comprising the steps of:
accumulating a list of zero or more input attributes, zero or more calculated attributes, zero or more intermediate output attributes, and zero or more final output attributes found by analyzing executable code while traversing from a first connector function to a last connector function in a first meta-directory integrator;
performing data flow analysis to yield an indicator for each attribute in said list of attributes, said indicator denoting as “unused” input attributes which neither directly or indirectly contribute to final output attributes;
modifying program code associated with said connector functions to eliminate accessing or storing said input attributes denoted as “unused” to produce modified connector function program code; and
producing in a computer readable medium a second meta-directory integrator comprised of said modified connector function program code.

2. The method as set forth in claim 1 wherein said step of accumulating attributes comprises accumulating attributes from lightweight directory access protocol integrator functions.

3. The method as set forth in claim 1 wherein said step of accumulating attributes comprises accumulating attributes from directory integrator assembly line functions.

4. The method as set forth in claim 1 wherein said step of modifying program code comprises modifying lightweight directory access protocol integrator program code.

5. The method as set forth in claim 1 wherein said step of modifying program code comprises modifying directory integrator assembly line functions.

6. The method as set forth in claim 5 wherein said modified code comprises JavaScript code.

7. The method as set forth in claim 1 wherein said step of producing in a computer readable medium a second meta-directory integrator comprises producing a directory integrator assembly line.

8. A system for producing a meta-directory integrator having improved data flow, the system comprising:
a list of zero or more input attributes, zero or more calculated attributes, zero or more intermediate output attributes, and zero or more final output attributes, said list being accumulated by analyzing executable code while traversing from a first connector function to a last connector function in a first meta-directory integrator;
a data flow analyzer adapted to perform data flow analysis to yielding an indicator for each attribute in said list of attributes, said indicator denoting as “unused” input attributes which neither directly or indirectly contribute to final output attributes;
a program code optimizer adapted to modify program code associated with said connector functions to eliminate accessing or storing said input attributes denoted as “unused”; and
a meta-directory integrator creator adapted to produce in a computer readable medium a second meta-directory integrator comprised of said modified connector function program code.

9. The system as set forth in claim 8 wherein said attribute list comprises attributes accumulated from lightweight directory access protocol integrator functions.

10. The system as set forth in claim 8 wherein said attribute list comprises attributes accumulated from directory integrator assembly line functions.

11. The system as set forth in claim 8 wherein said program code modifier is further adapted to modify lightweight directory access protocol integrator program code.

12. The system as set forth in claim 8 wherein said program code modifier is further adapted to modify directory integrator assembly line functions.

13. The system as set forth in claim 12 wherein said modified code comprises JavaScript code.

14. The system as set forth in claim 8 wherein said meta-directory integrator creator is further adapted to produce a directory integrator assembly line.

15. A computer-readable medium encoded with software for producing a meta-directory integrator having improved data flow, said software performing steps comprising:
accumulating a list of zero or more input attributes, zero or more calculated attributes, zero or more intermediate output attributes, and zero or more final output attributes found by analyzing executable code while traversing from a first connector function to a last connector function in a first meta-directory integrator;
performing data flow analysis to yield an indicator for each attribute in said list of attributes, said indicator denoting as “unused” input attributes which neither directly or indirectly contribute to final output attributes;
modifying program code associated with said connector functions to eliminate accessing or storing said input attributes denoted as “unused” to produce modified connector function program code; and
producing in a computer readable medium a second meta-directory integrator comprised of said modified connector function program code.

16. The computer-readable medium as set forth in claim 15 wherein said software for accumulating attributes comprises software for accumulating attributes from lightweight directory access protocol integrator functions.

17. The computer-readable medium as set forth in claim 15 wherein said software for accumulating attributes comprises software for accumulating attributes from directory integrator assembly line functions.

18. The computer-readable medium as set forth in claim 15 wherein said software for modifying program code comprises software for modifying lightweight directory access protocol integrator program code.

19. The computer-readable medium as set forth in claim 15 wherein said software for modifying program code comprises software for modifying directory integrator assembly line functions.

20. The computer-readable medium as set forth in claim 19 wherein said modified code comprises JavaScript code.
